(19) United States
(12) Patent Application Publication
(10) Pub. No.: US 2007/0156977 A1
(43) Pub. Date: Jul. 5, 2007

(54) Automatic location data determination in an electronic document

(76) Inventors: Gerd Martin Ritter, Heidelberg (DE); Christian Peter Haas, Heidelberg (DE)

Correspondence Address: KENYON & KENYON LLP, 1500 K STREET N.W., WASHINGTON, DC, 20005, US

(21) Appl. No.: 11/319,510

(22) Filed: Dec. 29, 2005

(51) Int. Cl. G06F 12/00

(52) U.S. Cl. 711/156; 707/205

(57) ABSTRACT

The automated data field processing of an input form includes the determination of a purpose identifier for the form. In the input form, input data is received associated with one or more data fields of the input form. Based on this input data, stored data is retrieved from a memory device and associated with further data fields of the input form. The automated data field processing includes determining location data for the input form based on the purpose identifier and at least one of the input data, the stored data or a combination of both. The location data identifies a particular location relating to the intended purpose of the business form and the location data is thereupon associated with the input form.

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

The present invention relates generally to automated data field determination and insertion in an electronic form document and more specifically to automatically determining location data for an electronic document.

In existing electronic document systems, there are numerous techniques for assisting the user in entering data into the electronic form. A common example of a data fill operation is based on previous data entry operations. For example, if a user utilizes an electronic mail program, input key recognition techniques may be used to anticipate a common electronic mail address. For example, if a person sends an electronic message to “user@address.com,” the electronic mail program may suggest the address after receiving the input “u.”

Another common technique is an approach commonly known as auto-fill. This feature allows for the automatic filling of multiple data fields in a multi-field input form. For example, if the form includes address information, the insertion of a person's name in the first data field may trigger the auto-filling of the data into the rest of the form. This technique can be commonly found in internet web sites where a user fills out an electronic form, such as an order form. One technique may include locally saved software code, e.g. cookies, that enable the auto-fill of the requisite information.

Data filling techniques are also found in database applications, such as customer relationship management (CRM) applications. These auto-fill features can provide a valuable time saving resource, inserting commonly used customer information or other information into electronic forms, thereby improving system efficiency. For example, if a sales representative or a call agent is taking a sales order from a repeat customer, auto-fill features may save the sales rep from having to re-enter all of the customer's pertinent information. Instead, the sales rep can enter the first few elements of the customer's information, allowing auto-fill features to enter the rest of the customer data, based not only on the previously entered information, but also the context of the data entry itself. The sales rep or call agent may then timely enter the sales order information without having to either make the customer wait or require the sales rep to go back and re-enter information that is already stored within the processing system.

These auto-fill features can provide a wide variety of information in electronic documents. As long as the information has been previously entered, known operations allow for the retrieval and insertion of this information in response to the entered input data. Although, current systems are limited by the type of information provided. These systems are limited to existing information readily ascertainable by a static electronic document. For example, in existing applications, electronic documents indicate contact information that may be associated with the customer information. If the document is a sales order, billing address information indicates where a bill is to be sent, which is often also a default delivery location. The billing information is customer information and the delivery location would be location information directed to a particular location. When the delivery information is different from the buyer's address, the user must then manually enter this location information. Current systems do not provide for the determination of this location information, which is information relating to a purpose of the electronic document, e.g. delivery address for a sales contract, because this information is dependent upon the intended purpose of the electronic document and existing systems do not determine the intended purpose of the electronic document.

One example of an existing application is an automatic partner determination system. A user might enter the name “Miller” for a potential buyer in a sales order form. From this buyer's name, other partner information may be determined, such as a ship-to field, a product recipient field and a payer field. In this system, the process to find the partner information can be performed by several steps, which can be configured by the user. A first technique is checking a master data file for the buyer to see if there is a fixed ship-to party. If not, a second technique is to check in the sales quote if a ship-to party has already been noted. And if neither step produces a ship-to address, the system then assumes the buyer as the ship-to party.

Even with the automatic partner determination system, the information relating to the buyer is either set to existing defined addresses of the buyer or must be manually entered. This system does not provide flexibility beyond a direct data retrieval based on the input data and if data cannot be retrieved or the right data is not available directly associated with the buyer, the system requires data entry. The location information, illustrated in the above example as ship-to information, cannot be determined because there is no determination of the intended purpose of the electronic document.

### BRIEF DESCRIPTION OF THE DRAWINGS

FIG. 1 illustrates a block diagram of one embodiment of an apparatus for automated data field processing of an input form;

FIG. 2 illustrates a graphical representation of one embodiment of a blank input form;

FIG. 3 illustrates the steps of a flowchart of one embodiment of a method for automated data field processing;

FIG. 4 illustrates a graphical representation of one embodiment of the input form of FIG. 2 including input data, stored data and location data;

FIG. 5 illustrates a block diagram of one embodiment of the determination of location data; and

FIG. 6 illustrates a block diagram of one embodiment of a processing environment including an apparatus for data field processing of an input form.

### DETAILED DESCRIPTION

With the inclusion of additional levels of information in input forms, which may be electronically displayed forms such as standardized input forms, it is beneficial to reduce the amount of input data required to complete the input form. With some input forms, there is the requirement for location data, which may be different from contact data, which is person's or company's contact information, and billing data, which may be the location to direct financial correspondences. Location data is more specifically related to a location associated with completing the purpose underlying the form itself. For example, if the input form is related to a service contract, the location may be the location where services are to be performed, which may be different from the contact data and the billing data. Through the utilization of the data within a form processing environment, the location data may be automatically determined and inserted into the input form.

FIG. 1 illustrates a block diagram of one embodiment of an apparatus 100 for automated data field processing of an input form, where the input form may include but not limited to a maintenance user interface and messages, such as XML messages, in an electronic system. The apparatus 100 includes a processing device 102 and a memory device 104, which is a stored data database. The apparatus 100 further includes a form database 106, an input device 108, an output device 110 and a storage device 112.

The processing device 102 may be one or more processing elements within a local or networked processing environment. The stored data database 104 and the form database 106 may be one or more suitable type of memory devices accessible by the processing device 102. The input device 108 and output device 110 may be suitable devices providing for input and output through the processing device 102 in accordance with known usage techniques for interfacing with the processing device 102. The storage device 112 may be a local or remote storage element or elements operative to provide executable instructions 114 for the processing device 102 to perform operations as described in further detail below. In one embodiment, the storage device 112 may be a computer readable medium, readable subject to recognized techniques for providing the executable instructions 114 from the medium 112 to the processing device 102. The stored data database 104 and the form database 106 may be accessible by the processing device 102 locally or across a networked connection 116.

In the embodiment of FIG. 1, the processing device 102 receives input commands 120 from the input device 108. One input command 120 may include a form retrieval request, for example a user using a database operating system may seek to load a particular input form. As an example, a user may seek to load a sales order form using known interfacing techniques to request the requested form. The processing device 102 transmits a form request command 122 and receives a blank form 124 from the form database 106.

In typical operations, the processing device 102 maintains an updated visual display for the user, therefore the processing device 102 may generate the output command 126 to the output device 110. In one example, the output device 110 may be a visual display, so the output command includes a visual display of the blank form 124.

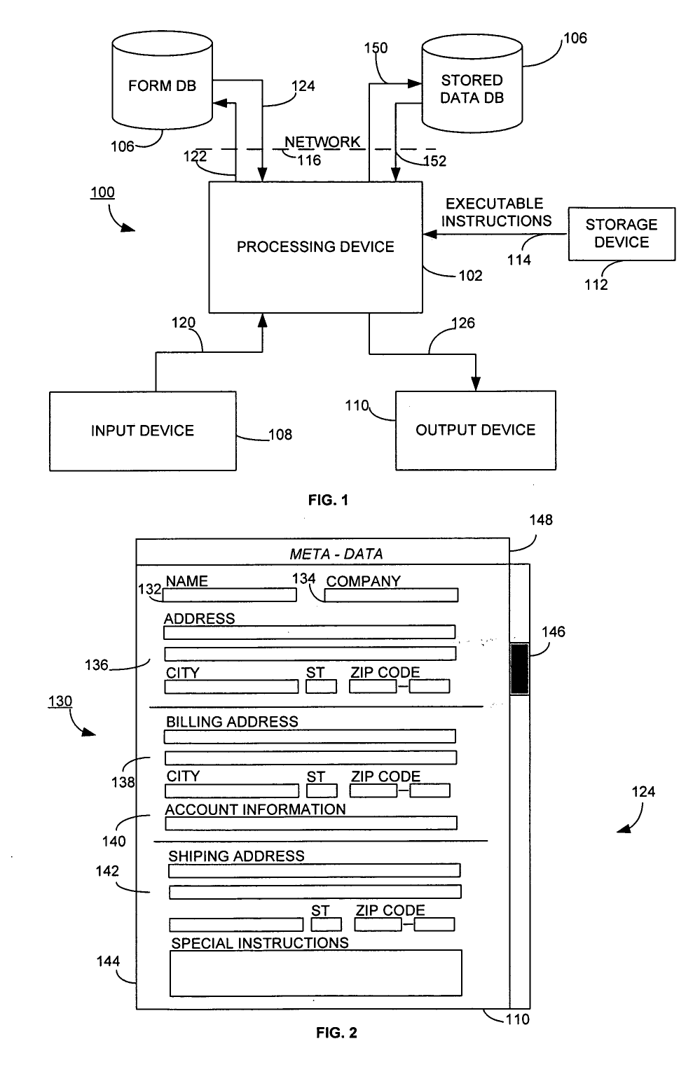

FIG. 2 illustrates a graphical representation of a visual display 130 of the input form 124 as may be seen on the output device 110. The input form 124 includes multiple data fields, for example a name field 132, company field 134, contact fields 136, billing address fields 138, account information field 140, shipping location address fields 142 and a special instructions field 144. The display 130 further includes a scrollbar 146 indicating that there may also exist further data fields not currently visible. Also illustrated in FIG. 2, the form 124 may further include meta-data 148. As with meta-data, this data 148 is associated with the form 124 and is not visibly displayed on the output device 110. As illustrated in FIG. 2, the form 124 may include such data 148 associated therewith.

Referring back to FIG. 1, the processing device 102 thereupon receives further input commands 120 from the input device 108. In one example, the input commands 120 may include input data associated with one or more of the data fields of the input form 124. For example, the input data may be the insertion of a customer's name in the name field 132 of the form 124 of FIG. 2. Using known techniques for populating the data fields, the processing device 102 may perform a recognition operation, recognizing additional data for the input form.

Referring back to FIG. 1, the processing device 102 generates a data retrieval command 150 to retrieve stored data 152 from the stored data database 104. The stored data 152 may be input data that is already associated with the input data previously received by the processing device 102. For example, if the input data indicates a user's name, the stored data 152 may be the contact information. The processing device 102 may thereupon associate the corresponding fields with the input form 124. In the example of a visual display on the output device 110, this association may include a visual automated population of various data fields.

The processing device 102 is operative to perform further operations to perform the automated data field processing. These operations may be in response to the executable instructions 114. The processing device 102 is operative to determine a purpose identifier, which may be a data field indicating an intended purpose of the input form 124. This determination may be performed by reading meta-data (148 of FIG. 2) associated with the input form 124. This determination may also be performed by recognizing the form itself, for example if the form is a sales form, the purpose identifier may identify the intended purpose as sales, or if the form is a service order form, the purpose identifier may identify the intended purpose for performing a service or repair job, or if the form is an appointment form, the purpose identifier may identify the intended purpose for coordinating a meeting time and place for parties.

With the knowledge of the purpose identifier, the processing device may thereupon determine location data for a location field. In the example of FIG. 2, the contact fields 136 and the billing address field 138 may be automatically populated using the input data. But the shipping location address 142 is determined based on the intended purpose identified by the purpose identifier, and the input data and/or the stored data, where in this example, the intended purpose is to conduct a sales transaction.

The processing device 102 may thereupon retrieve additional data or determine the association of already retrieved data as the location data. The processing device 102 predicates this step on the location information already being determined in the system itself. Either the location information has previously been entered or instructions for the specific information are already encoded.

In one embodiment, corresponding functional instructions may provide the determination of the location data. For example, an instruction may be that for a sales order form relating to a particular user or company, the location data is a specific location that is different from the contact data 136 and/or the billing data 138. These instructions may provide for the processing device 102 to retrieve further data from the stored data database 104, where this data is associated with the contact data, such as the name 132 or the company 134.

In another embodiment, the location data may include additional information, such as the special instructions field 144 illustrated in the form 124. This additional information, as well as the location information, may be predicated on other fields of the stored data or the input data. In one example, if the input data relates to a hazardous material, the location data may include special handling instructions or the location data itself may be modified to reflect that delicate nature of the materials. For example, a company may require all hazardous material to be delivered to a special gate instead of a main receiving unit.

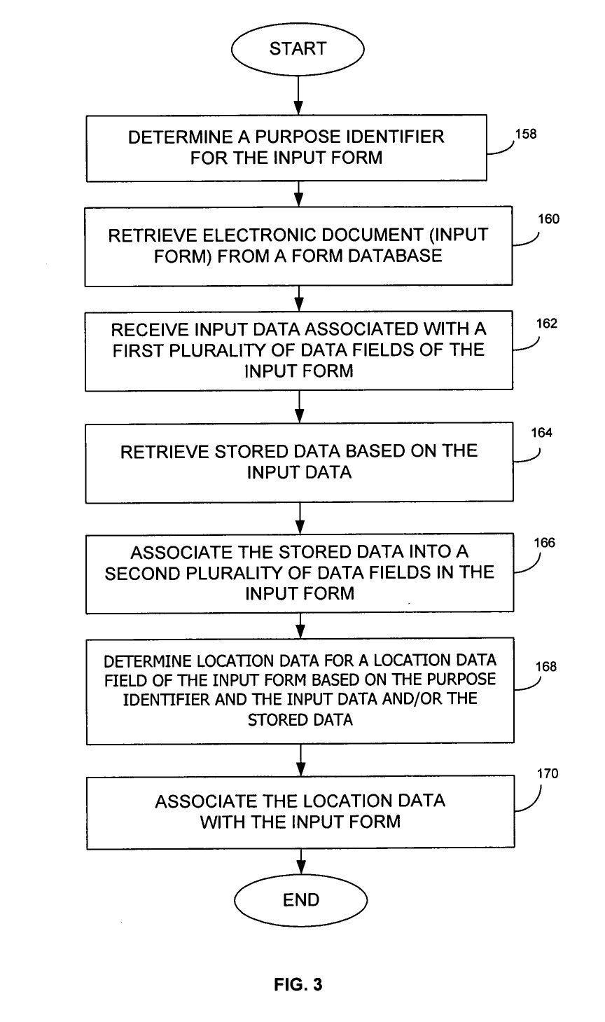

FIG. 3 illustrates a flowchart of the steps of one embodiment of a method for automated data field processing of an input form, such as form 124 of FIG. 2. These steps may be performed by one or more processing devices, such as the processing device 102 of FIG. 1. The first step, step 158, is determining a purpose identifier that indicates an intended purpose for the input form. As discussed above, this may be performed by recognizing the form and comparing the form type with a list of intended purposes, reading meta-data associated with form or other techniques as recognized by one skilled in the art. The next step, step 160, is retrieving an electronic document, an input form, from a form database. For example with FIG. 1, the form 124 is retrieved from the form database 106.

The next step, step 162, is receiving input data associated with a first plurality of data fields of the input form. This step is typically performed by a user inputting input data into an input device, such as the input device 108 and the data is received by the processing device 102. Although, other embodiment are envisioned, including the input data being received from another processing device or application module, such as within a common database application launching a specific input form pre-populating various amounts of input data.

The next step, step 164, is retrieving stored data based on the input data. This may be performed using known retrieval techniques where the stored data may be stored either locally or remote to the processing device 102 or a processing environment executing the executable instructions 114. The next step, step 166, is associating the stored data into a second group of data fields within the input form. In a visual display, this step may include populating the corresponding fields of the input form.

The next step, step 168, is determining location data for a location data field of the input form based on the purpose identifier and, the input data and/or the stored data. As described above and in further detail below, the location data may be retrieved from a storage location, may involved the manipulation of existing retrieved data or may be a combination thereof.

The final step, step 170, of this embodiment is associating the location data with the input form. The association may be performed by associating the location data with corresponding data fields. In a visual display, this association may further include the visual insertion of the location data in corresponding display fields. As such, one embodiment of a method for automated data field processing is complete.

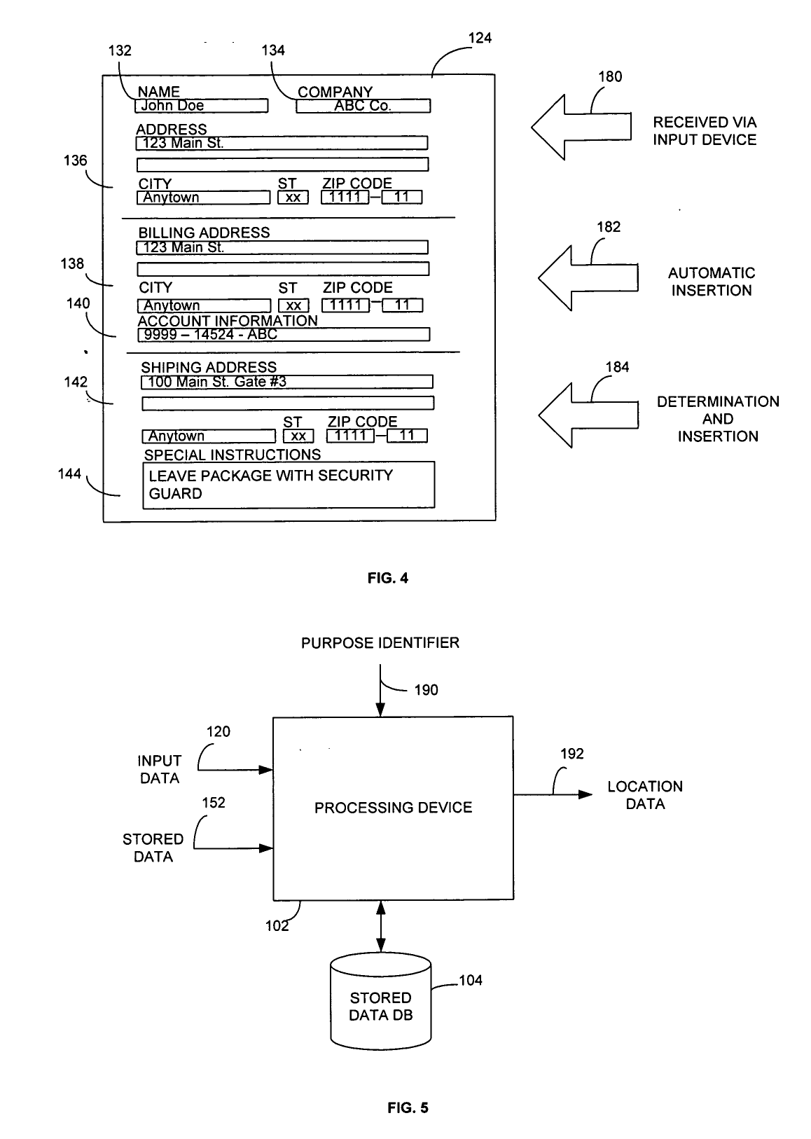

FIG. 4 illustrates another embodiment of the visual display of the input form 124. Various operations are performed relative to this form, where these operations are performed by a processing device (e.g. processing device 102 of FIG. 1) providing the visual display illustrated in FIG. 4.

A first operation 180 is receiving input data using an input device. The input data may include data entry of a user's name, here the example is John Doe. In one embodiment, the processing device may perform recognition based on limited amounts of data entry. For example, the next step of automated insertion 182 may be performed based on the limited input of John Doe. In another embodiment, the processing device may require further information, such as the company name, 134, such as if there are numerous John Does in the processing system.

The available data fields are then populated. In this example, the contact address information 136, billing address information 138 and account information 140 fields may be populated as this information is associated with the user John Doe in the context of the form itself. Although, in the example of the sales form 124 of FIG. 4, the location information relates to a ship-to or shipping location address. This information is not readily ascertainable by just the input data because the location data may be specific to the intended purpose of the form, e.g. a service order form may have different location information than a sales order form or a meeting appointment form. Additionally, the location data may be specific to the intended purpose of the form itself. For example, if the form is a sales form relating to the purchase of a product, for example Helium gas, the location data may be in the context of the user being John Doe and the product being Helium Gas. In this example the shipping location of the customer John may depend on the product being sold, e.g. such as for security reasons if the product was considered dangerous or required special handling.

Illustrated in FIG. 4, the final step to assembling the location data in the input form is the determination and insertion of the location data 184. The determination of the location data may be based on a single data entry operation, as described above or may be through a multi-step approach having one or more screens or input commands allowing for the automated determination of the location data associated with the purpose of the document. FIG. 5 illustrates a block diagram of one embodiment for completing this step. The processing device 102 performs a processing step based on one or both of the input data 120 and the stored data 152, and an intended purpose data field 190 indicating the intended purpose of the form.

FIG. 5 illustrates the processing device 102 as receiving the purpose identifier 190, which may be a data field indicating the underlying purpose of the form. FIG. 5 graphically illustrates the device 102 receiving the identifier 190, although additional embodiments include the processing device 102 determining the identifier 190 based on additional information. As discussed above, the intended purpose may be determined based on meta-data or other identifier data associated with or contained within the form. Additionally, the intended purpose may be determined based on referencing the form itself or data within the form to a table or other reference object to retrieve the corresponding information. For example, if the form has a particular reference number, a look-up table may have a corresponding intended purpose associated with that particular reference number.

The input data 120 may be the information received to provide the retrieval of the stored data. In the example of FIG. 4, the input data 120 may be the name 132 and company 134 data. The stored data 152 may be, once again using the example of FIG. 4, the address 136 and/or billing address 138. In the performance of the step 184 of FIG. 4, the processing device 102 performs designated operations, such as in response to embedded instructions, where the embedded instructions may be internally set or may be configurable by a user or customer to a customized operation. The location data may be included in the data previously retrieved from the stored data database 104 or the processing device may need to perform another data retrieval operation.

In the example of FIG. 4, the location data may be determined based on instructions associated with the company 134 and address 136. For example, instructions may provide for when the intended purpose is sales and the company is ABC Co. with an address in state XX (part of 136 of FIG. 4), the processing device may be instructed to retrieve additional location information associated with this information. In the example of a sales form, an initial check may be performed to determine if there is a specific gate or designated delivery location associated with a particular product. If this specific location information is maintained, insert into the document as the shipping location address 142. Although, if there is not specific information relating to the product, the process may then examine if the company has a specific delivery address. If the specific address is available, this address becomes the shipping location address 142. If no specific address is maintained, the instructions may then simply utilize the standard address for the company as the shipping location address 142. Additionally, it may include special instructions 144, as well as other information, that may be determined based on the type of elements included in the sales form. For example, if the sales form relates to a high-value item, it might require being left with a security person or might require obtaining a signature.

In the processing device 102 of FIG. 5, the location data 192 is determined and provided to the input form. As illustrated in FIG. 4, the data in the fields 142 and 144 are populated with a shipping location address that includes gate information and special instructions. It is recognized that other intended purposes identified by the purpose identifier may provide related location information, including but not limited to a service order form having a location data field representing where a service person is to go or an appointment form indicating a meeting location. Additionally, the above technique may additionally be used to determine more than one address in a single document. Similar operations may be performed for finding additional location address information as described above, including determining the location data through a multi-step process, a single process based on existing data and the purpose of the document or other suitable techniques.

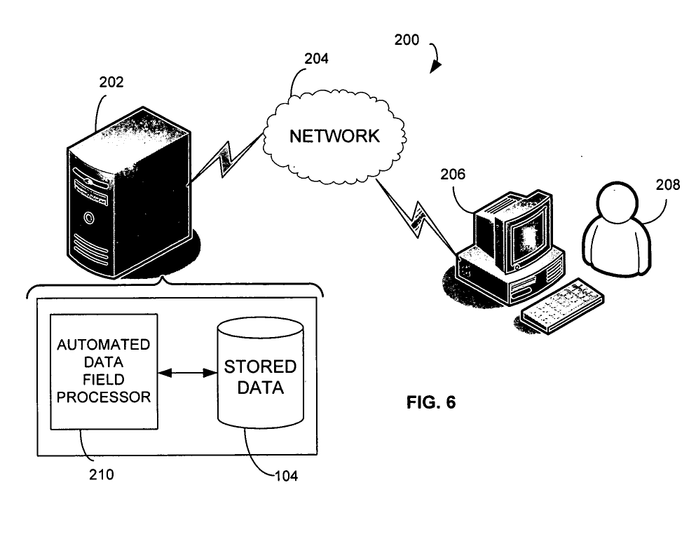

FIG. 6 illustrates a processing environment 200 including a server 202, a network 204 and a computing device 206 usable by a user 208. The user 208 may utilize the computing device 206 to access the server 202 across the network 204. In this embodiment, the server 202 includes an automated data field processor 210 and the stored data database 104. The automated data field processor 210 may operate similar to the processor 102 described above, operative to perform operations as outlined in the steps of the flowchart of FIG. 3, among other operations.

Through the network 204, automated data field processing may be performed for the automatic determination of location data for a location data field, as described above, and providing a visual display to the computing device 206. Not illustrated, the server 202 may be in operative communication with other servers across the network 204 to perform other functions associated with the input forms. For example, if the input form is a sales order form, the server 202 may be in communication with an order processing server across the network to fulfill the corresponding order of the form.

Using the purpose identifier indicating the intended purpose of the input form allows for the automated data field processing to include location data associated with the electronic form. While previous techniques were limited to static data retrieval operations, problems arose when different location data is needed for different purposes. Through the determination of the intended purpose of the form and the associated instructions, the input data fields are automatically processed to include the appropriate data for completing the underlying form and specific to the intended purpose of such form.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. An apparatus for automated data field processing of an input form, the apparatus including:
a memory device storing stored data; and
a processing device, in response to executable instructions, operative to:
determine a purpose identifier for the input form;
receive input data associated with a first plurality of data fields of the input form;
retrieve stored data from the memory device based on the input data;
associate the stored data with a second plurality of data fields;
determine location data for a location data field of the input form based on the purpose identifier and at least one of the input data and the stored data; and
associate the location data with the input form.

2. The apparatus of claim 1 further comprising:
an input device operative to receive input information and generate the input data receivable by the processing device.

3. The apparatus of claim 1 further comprising:
an output device operative to receive an output command from the processing device and output the input form.

4. The apparatus of claim 1 wherein the processing device is further operative to, prior to the retrieval of the stored data, analyze the input data to determine data retrieval fields and access the memory device using the data retrieval fields.

5. The apparatus of claim 1 wherein the purpose identifier of the input form indicates a service order form, the location data field represents a location for a service person to execute a service.

6. The apparatus of claim 1 wherein the purpose identifier of the input form indicates a sales order form, the location data field represents a ship-to location.

7. The apparatus of claim 1 wherein the purpose identifier of the input form indicates an appointment form, the location data field represents a meeting location.

8. The apparatus of claim 1, wherein the stored data is billing address information such that the processing device is operative to determine the location data based on the purpose identifier and at least one of the input data and the billing address information.

9. The apparatus of claim 1, wherein the processing device, when operative to receive the input data associated with the first plurality of data fields, receives the input data in a multi-step input process.

10. A method for automated data field processing of an input form, the method comprising:
determining a purpose identifier for the input form;
receiving input data associated with a first plurality of input fields of the input form;
retrieving stored data based on the input data;
associating the stored data with a second plurality of data fields of the input form;
determining location data for a location data field based on the purpose identifier and at least one of the input data and the stored data; and
associate the location data with the input form.

11. The method of claim 10 further comprising:
prior to retrieving the stored data, analyzing the input data to determine data retrieval fields and accessing a data storage device using the data retrieval fields.

12. The method of claim 10 wherein the purpose identifier of the input form indicates a service order form, the location data field represents a location for a service person to execute a service.

13. The method of claim 10 wherein the purpose identifier of the input form indicates a sales order form, the location data field represents a ship-to location.

14. The method of claim 10 wherein the purpose identifier of the input form indicates an appointment form, the location data field represents a meeting location.

15. The method of claim 10 wherein the stored data is billing address information, the method further comprising;
using the purpose identifier and the billing address information to determine the location data.

16. The method of claim 10, wherein the receiving of the input data associated with the first plurality of data fields includes receives the input data in a multi-step input process.

17. A computer readable medium including executable instructions that when read by a processing device provide for:
retrieving an input form from a storage device;
determining a purpose identifier for the input form;
receiving input data associated with a first plurality of data fields of the input form;
retrieving stored data based on the input data;
associating the stored data with a second plurality of data fields of the input form;
determining location data for a location data field based on the purpose identifier and at least one of the input data and the stored data; and
associating the location data with the input form.

18. The computer readable medium of claim 17 including further executable instructions that when read by the processing device provide for:
prior to retrieving the stored data, analyzing the input data to determine data retrieval fields and accessing a second storage device using the data retrieval fields.

19. The computer readable medium of claim 17 wherein the purpose identifier of the input form indicates a service order form, the location data field represents a location for a service person to execute a service.

20. The computer readable medium of claim 17 wherein the purpose identifier of the input form indicates a sales order form, the location data field represents a ship-to location.

21. The computer readable medium of claim 17 wherein the purpose identifier of the input form indicates an appointment form, the location data field represents a meeting location.

22. The computer readable medium of claim 17 wherein the stored data is billing address information, the medium including further instructions that when read by the processing device provide for:
using the purpose identifier and the billing address information to determine the location data.

23. The computer readable medium of claim 17, wherein the receiving of the input data associated with the first plurality of data fields includes receives the input data in a multi-step input process.
